(19) United States
(12) Patent Application Publication
(10) Pub. No.: US 2015/0257375 A1
(43) Pub. Date: Sep. 17, 2015

(54) BAIT LIGHTING AND FISH ATTRACTING BOBBER

(71) Applicants: Mark Byrd, Mobile, AL (US); Bret Faircloth, Mobile, AL (US)

(72) Inventors: Mark Byrd, Mobile, AL (US); Bret Faircloth, Mobile, AL (US)

(21) Appl. No.: 14/658,153

(22) Filed: Mar. 14, 2015

Related U.S. Application Data
(60) Provisional application No. 62/009,781, filed on Jun. 9, 2014.
(60) Provisional application No. 61/953,172, filed on Mar. 14, 2014.

(51) Int. Cl. A01K 93/02; A01K 97/12

(52) U.S. Cl. CPC A01K 93/02; A01K 97/125

(57) ABSTRACT

A bobber having an internal light for illuminating bait suspended in the water below the bobber is provided. The bobber has a wide upper portion and a lower portion in the shape of an inverted cone pointed downward into the water when the bobber is floating. The internal light is positioned in the lowest part of the bobber when the bobber is in an upright vertical position. The bobber is very stable in the water and effectively and consistently focuses the light directly on the bait. Thus, the bobber is particularly effective in attracting fish to the bait.

### FIELD OF THE INVENTION

A preferred embodiment of the invention refers to an illuminating and fish attracting bobber capable of illuminating bait or an area of water below the bobber.

### BACKGROUND

A fishing bobber, also called a float, is an item of angling equipment that is attached to a fishing line. The bobber floats on the surface of the water while a fishing bait with a hook is suspended in the water below the bobber. Bobbers come in many different shapes and sizes and can be made from various materials, such as wood, cork, plastic, reed, or any other suitable buoyant material. There are many different styles and varieties of floats.

Traditionally, a bobber or float serves three main purposes. First, it suspends the bait at a predetermined depth below the surface of the water. Second, due to its buoyancy, it can carry the bait to otherwise inaccessible areas of water by allowing the float to drift in the prevailing current. Third, it can serve as a bite indicator. When a fish strikes the bait, the fish will typically pull the float below the surface of the water, thereby indicating a bite.

More recently, lights and other illuminating means, such as chemical glow sticks, have been added to bobbers. These illuminated fishing bobbers are primarily used for night fishing to show an angler the position of his bobber in the dark and/or as a bite indicator.

Other illuminated fishing bobbers known in the art light up when a specific action, such as the bobber turning on its side, occurs. These actions are meant to alert the angler that a fish has likely struck the bait. Generally, the bite indicator type of illuminated fishing bobbers shine only when a strike takes place. Other illuminated bobbers known in the art have lights that remain on constantly and are used solely for spotting the bobber in the dark.

In addition to illuminated bobbers for indicating a bite or for showing the bobber's position in the dark, some known illuminating bobbers shine light downward toward an angler's bait. However, problems exist with these types of bobbers. For instance, bobbers often move around during use when they encounter waves in the water, thereby causing the direction that the light is focused in to shift back and forth more than is ideal. This movement focuses the light away from the bait at times, thereby reducing the effectiveness of the bobber in attracting fish to the bait. This problem is especially associated with spherical bobbers, though bobbers having other shapes experience the problem as well.

As noted from the foregoing, these and other problems exist in the fields relating to illuminating bobbers based primarily on the current state of the art. Therefore, a need exists in the art for a fishing bobber having a light housed therein that is capable of effectively and consistently focusing light downward onto the bait for attracting fish to the bait. Furthermore, a need exists in the art for a fishing bobber having a light housed therein that floats in a relatively stable position without excessive movement when encountering waves.

### SUMMARY

A preferred embodiment of the invention is directed to a floating bobber capable of effectively and consistently illuminating bait suspended in the water below the bobber in order to attract fish to the bait. A light, which is preferably an LED light, is housed within the bobber and is used to illuminate the bait when fishing at night. The bobber has a low center of mass, and the light is positioned very near the bottom of the bobber when it is in an upright position. In addition, the shape of the body of the bobber provides greater stability when floating in the water so that the bobber remains in a vertical, upright position as much as possible, which keeps the light focused downward onto the bait as effectively as possible. All of these features provide for a bobber that is specifically designed for illuminating bait for attracting fish and that is more effective in doing so compared to other illuminating bobbers known in the art.

The bobber has a body comprising an upper bobber housing joined to a lower bobber housing to form a single, continuous body. The outer shape of the upper bobber housing is generally in the shape of a hemispherical dome. The upper bobber housing further comprises a top opening leading into a vertical cylindrical cavity within the upper bobber housing. The top end of the cylindrical cavity has a female threaded section. The cylindrical cavity houses the light and a battery housing, which holds batteries for powering the light. The bottom end of the cylindrical cavity has an aperture through which the light is inserted when the light and batteries are installed in the bobber. The bobber further comprises a cap having male threads. The cap is threaded into the cylindrical cavity to seal the light and batteries inside.

The lower bobber housing is generally in the shape of a circular cone, which preferably has a concave curved outer surface. The cone is inverted when the bobber is in a vertical upright position such that the apex of the cone is pointed downward below the surface of the water when the bobber is floating. The apex of the inverted cone is truncated, thereby creating a flat bottom surface. The flat bottom surface is translucent, and the light is positioned just above this surface when the light and batteries are properly installed in the bobber. Thus, the light shines downward into the water through the bottom surface of the lower bobber housing. In a preferred embodiment, all parts of the body of the bobber are translucent, though some parts may be opaque. In other embodiments the bobber, or parts thereof, are transparent.

To manufacture the bobber, the upper bobber housing and the lower bobber housing are joined together to create a permanent, watertight seal. This seal may be created by pressure, heat, glue, or other suitable means. The batteries are installed in the battery housing, and the light and battery housing are inserted into the cylindrical cavity within the upper bobber housing. The cap is then threaded into the cavity to complete the assembly.

Accordingly, it is one object of the present invention to provide a bait illuminating and fish attracting bobber having a light housed therein. It is another object of the present invention to provide a bobber having a shape that provides added stability when floating in order to minimize any shifting in the direction of the light. It is yet another object of the present invention to provide a bobber specifically designed to focus and effectively direct light downward onto bait suspended in the water below the bobber. Further, it is an object of the present invention to provide a bobber having a low center of mass.

### DESCRIPTION OF THE DRAWINGS

These and other features, aspects, and advantages of the present invention will become better understood with regard to the following description, appended claims, and accompanying drawings where:

FIG. 1 is a perspective view of a bobber embodying features of the present invention.

FIG. 2 is a top plan view of a bobber embodying features of the present invention.

FIG. 3 is a bottom plan view of a bobber embodying features of the present invention.

FIG. 4 is an exploded view of a bobber assembly embodying features of the present invention.

FIG. 5A is a perspective view of a bobber embodying features of the present invention in use with fishing line.

FIG. 5B is a perspective view of a bobber embodying features of the present invention in use with fishing line.

FIG. 5C is a perspective view of a bobber embodying features of the present invention in use with fishing line.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

As used herein, the term “cone” refers to a standard cone having a lateral, or outer, surface defined by straight line segments connecting the base of the cone to the apex. However, as used herein, the term “cone” may also refer to a similar geometric shape in which the lateral surface is defined by concave curves. Additionally, as used herein, the term “cone” may also refer to a conical frustum, which is a cone having a truncated apex.

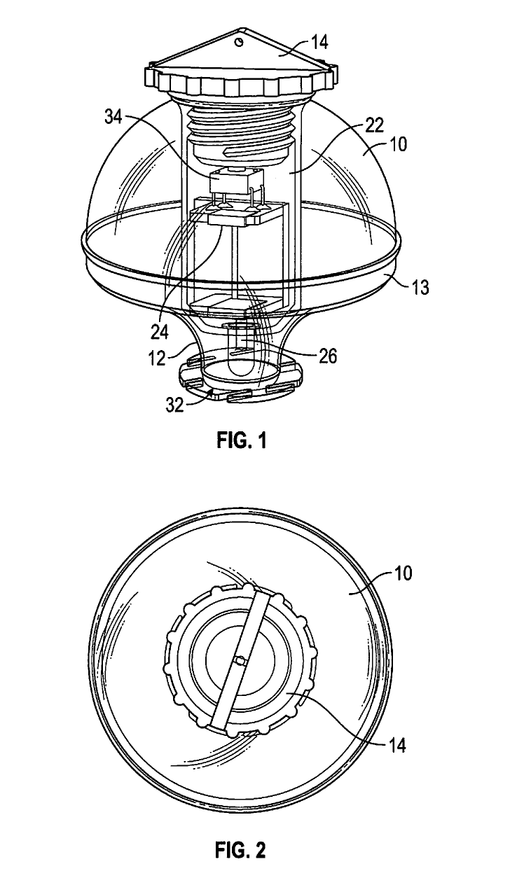

A preferred embodiment of the invention is directed to a floating bobber capable of effectively and consistently illuminating bait suspended in the water below the bobber in order to attract fish to the bait. FIGS. 1-4 illustrate a preferred embodiment of the bobber. The bobber comprises a light 26, which is housed within the bobber, for illuminating the bait when fishing at night. The light 26 is preferably an LED light. As shown in FIG. 1, the light 26 is positioned very near the bottom of the bobber when the bobber is in an upright position. The bobber has a low center of mass. In addition, the shape of the body of the bobber provides greater stability when floating in the water so that bobber remains in a vertical, upright position as much as possible, which keeps the light focused downward onto the bait as effectively as possible. All of these features provide a bobber that is specifically designed for illuminating bait for attracting fish and that is more effective in doing so compared to other illuminating bobbers known in the art.

The bobber has a body comprising an upper bobber housing 10 and a lower bobber housing 12. When the bobber is floating in water, the upper bobber housing 10 generally floats above the surface of the water, and the lower bobber housing 12 is generally submerged below the water surface. The outer shape of the upper bobber housing 10 is generally in the shape of a hemispherical dome. The lower bobber housing 12 is generally in the shape of a circular cone. The lower bobber housing 12 has a circular flange 13 corresponding to the upper bobber housing 10, which is joined to the lower bobber housing 12 at the flange 13 to form the body of the bobber.

As shown in FIGS. 1 and 4, the circular cone of the lower bobber housing 12 preferably has a concave curved outer surface. The cone is inverted when the bobber is in a vertical upright position, as shown in FIG. 1, such that the apex of the cone is pointed downward below the surface of the water when the bobber is floating. The apex of the inverted cone is truncated, thereby creating a flat bottom surface 32. The flat bottom surface 32 is translucent, and the light 26 is positioned just above this surface 32 when the light 26 is properly installed in the bobber. Thus, the light 26 shines downward into the water through the bottom surface 32 of the lower bobber housing 12.

As shown in FIG. 4 he upper bobber housing 10 further comprises a top opening 20 leading into a vertical cylindrical cavity 22 within the upper bobber housing 10. The cylindrical cavity 22 has a top end and a bottom end. The top end of the cylindrical cavity 22 has a female threaded section 18. When the bobber is completely assembled, the cylindrical cavity 22 houses the light 26 and a battery housing 24, which holds batteries (not shown) for powering the light 26. The bottom end of the cylindrical cavity 22 has an aperture 28 through which the light 26 is inserted when the light 26 and batteries are installed in the bobber. The battery housing 24 has a base 30 with a larger diameter than the aperture 28. Thus, the base 30 prevents the battery housing 24 from falling through the aperture 28 and holds the light 26 in place just above the flat bottom surface 32 of the lower bobber housing 12. The battery housing 24 rests on top of the light 26 and physically contacts the light 26. The battery housing 24 comprises a mechanical pressure switch 34 located on the top end of the battery housing 24, as illustrated in FIG. 1. The battery housing 24 is made of a metal material and is designed to allow electrical current to flow from the batteries to the light 26.

The bobber further comprises a cap 14 having male threads 16. The cap 14 is threaded into the female threads 18 at the top end of the internal cavity 22 of the upper bobber housing 10. In a preferred embodiment, the cap 14 has an O-ring 15 made of rubber or similar material sized to fit around the male threads 16 of the cap 14. When the cap 14 is tightly threaded into the upper bobber housing 10, the O-ring 15 forms a watertight seal between the cap 14 and the opening 20 to the cylindrical cavity 22. Thus, the cap 14 seals the light 26 and batteries inside the upper bobber housing 10, thereby preventing the light 26 or batteries from getting wet when using the bobber.

As the cap 14 is threaded into the cylindrical cavity 22, the bottom of the cap 14 comes into contact with the mechanical pressure switch 34, which has a switch activator 36 located on top of the switch 34. As the bottom of the cap 14 moves downward, the switch activator 36 is forced into a depressed position. When the switch activator 36 is depressed, the switch 34 closes an electrical contact, thereby providing battery power to the light 26. The cylindrical cavity 22, the battery housing 24, and the cap 14 are sized so that the light 26 is activated by the switch 34 when the cap 14 is threaded tightly into the upper bobber housing 10. However, a user can deactivate the light 26 simply by unscrewing the cap 14 by a few turns. In this unscrewed configuration, the cap 14 will remain securely attached to the bobber and will hold the battery housing 24 and light 26 in place, although the seal formed by the O-ring 15 may not be completely watertight. This feature allows the user to quickly and easily activate and deactivate the light 26 before and after use simply by turning the cap 14 a few times. This feature preserves the battery life when the bobber is not in use.

In a preferred embodiment, LR44 1.5 volt button cell batteries are used to power the light 26. The battery housing 24 is preferably sized to hold two LR44 batteries. However, it should be understood that different types of batteries may be utilized with the present invention and the battery housing 24 may be sized differently according to the desired battery type.

The upper bobber housing 10, lower bobber housing 12, and cap 14 are preferably constructed of plastic, though it should be understood that these components may be constructed of any suitable material. In a preferred embodiment, the upper bobber housing 10, lower bobber housing 12, and cap 14 are constructed of acrylonitrile butadiene styrene (ABS) plastic. As illustrated in FIG. 1, the interior of the assembled bobber surrounding the cylindrical cavity 22 is preferably hollow. In an alternative embodiment, the interior of the bobber may comprise cork, foam, or any similar buoyant material. The bobber may further comprise a weight (not shown) made of metal, or any similar weighted material, located in the lower bobber housing 12 in order to lower the bobber's center of mass, which helps to stabilize the bobber when floating. In one embodiment, the bobber may comprise both buoyant material and weighted material. A relatively wide, buoyant upper bobber housing 10 combined with a pointed, weighted lower bobber housing 12 produces a more stable bobber with a lower center of mass. The increased stability keeps the light directed straight down onto the bait as much as possible and thus prevents the light from shifting back and forth away from the bait when using the bobber.

In a preferred embodiment, the upper bobber housing 10, lower bobber housing 12, and cap 14 are made of translucent or transparent plastic. Although the primary purpose of the light 26 is to illuminate the bait to attract fish, some light will also shine through a translucent upper bobber housing 10. This light will additionally help an angler see the floating bobber at night and indicate whether the bobber has been submerged due to a fish biting on the line. However, the only portion of the bobber that must be translucent is the bottom surface 32 because this is the part of the lower bobber housing 12 through which the light 26 shines downward onto the bait. Any other portion of the bobber may be opaque and still fall within the scope of the present invention.

In one embodiment, the upper bobber housing 10, lower bobber housing 12, and cap 14 are made of green translucent plastic, thereby causing a green light to shine downward onto the bait. The Applicant has surprisingly found that green light is particularly effective in attracting fish to the bait. Alternatively, only the lower bobber housing 12 or the bottom surface 32 of the lower bobber housing 12 may be made of green translucent plastic. As another alternative, the body of the bobber may be made of clear translucent plastic, and the bulb of the light 26 may be green. However, it should be understood that the bobber components may comprise translucent plastic of any color and still fall within the scope of the present invention.

In order to manufacture the bobber of the present invention, the upper bobber housing 10, lower bobber housing 12, and cap 14 are injection molded into individual components having shapes as described above and as illustrated in FIGS. 1 and 4. The upper bobber housing 10 and the lower bobber housing 12 are then joined together at the lower housing flange 13. In a preferred embodiment, the upper bobber housing 10 and the lower bobber housing 12 are joined together by applying an adhesive to the lower housing flange 13 and/or to the circular contact surface on the upper bobber housing 10 and then contacting the two components together. The adhesive is then allowed to dry. The adhesive may be glue, cement, or any similar material that is capable of forming a permanent airtight and watertight bond. In an alternative embodiment, the upper bobber housing 10 and the lower bobber housing 12 are joined together by heating each of the plastic components along each respective contact surface to the melting point of the plastic and then allowing the plastic to cool to form the bond.

Once the upper bobber housing 10 and the lower bobber housing 12 have been joined together to form a single, continuous body for the bobber, the light 26 is inserted through the cylindrical cavity 22 of the upper bobber housing 10 and into the aperture 28. Batteries are then installed in the battery housing 24, which comprises a mechanical pressure switch 34. The battery housing 24 is then inserted into the cylindrical cavity 22 such that the pressure switch 34 is at the opposite end of the battery housing 24 from the light 26. Next, the cap 14 is threaded into the cylindrical cavity 22 of the upper bobber housing 10 until the O-ring 15 forms a watertight seal, thereby completing the assembly.

If a user of the bobber needs to replace the light 26 and/or batteries, he can simply unscrew the cap 14 from the assembly and remove the battery housing 24 and the light 26. The light 26 and/or batteries may then be replaced and reinstalled as described above.

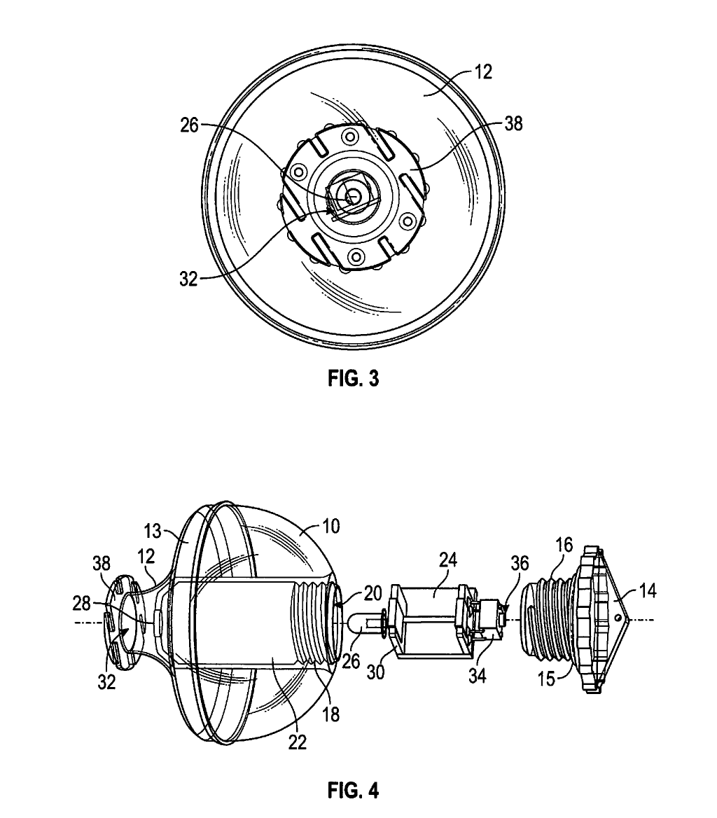

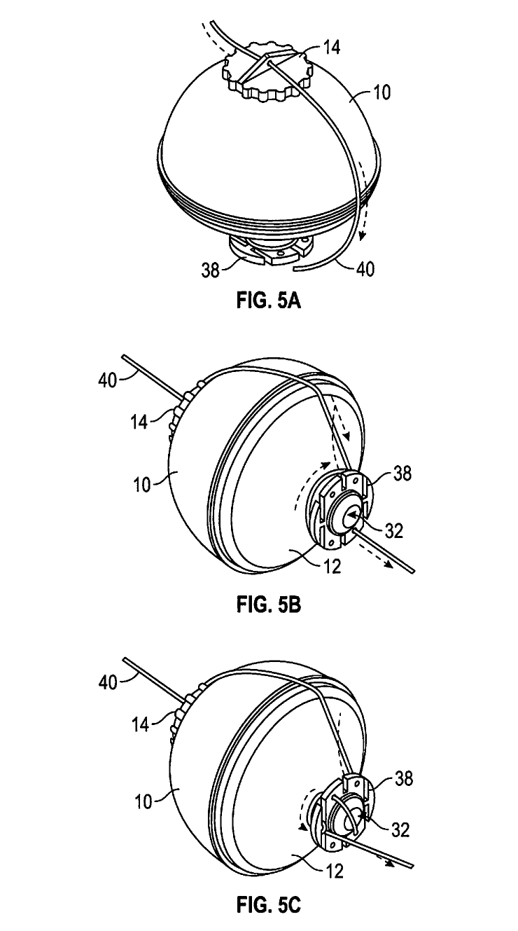

Once the bobber has been completely assembled, an angler must then attach the bobber to fishing line in order to use the bobber. FIGS. 5A-5C illustrate a preferred method of attaching the line 40 to the bobber. The lower bobber housing 12 comprises a fishing line holder 38. As shown in FIGS. 3 and 5A, the line holder 38 is a circular element attached to the outer perimeter of the pointed end of the lower bobber housing 12. The line holder comprises a plurality of small holes and grooves. To attach the line 40 to the bobber, the line 40 is first fed through a small hole in the cap 14, as shown in FIG. 5A. The line 40 is wrapped around the outer perimeter of the pointed end of the lower bobber housing 12 and then fed through one of the holes in the line holder 38, as shown in FIG. 5B. Optionally, the line 40 may then be looped around any of the grooves in the line holder 38 and/or fed through any of the other holes in the holder 38, as shown in FIG. 5C, as necessary to prevent the bobber from sliding along the line 40. In an alternative embodiment, the line 40 may be fed through the hole in the cap 14 and then fed through only one hole in the line holder 38. In this case, the bobber may function as a sliding bobber that freely slides along the length of the fishing line 40. Although FIGS. 5A-5C illustrate a preferred method of attaching fishing line to the bobber, it should be understood that line may be attached to the bobber by spring loaded attachment points, simple loops, or any other known methods for attaching fishing line to a bobber.

Versions of the illuminated bobber disclosed herein have many advantages over other illuminated bobbers. Some of these advantages include, but are not limited to the following: ability to effectively and consistently focus light downward onto the bait, stable floatation that prevents the light from shifting away from the bait, easy changing of batteries, low cost of manufacture, and overall ease of use. It is understood that versions of the invention may come in different forms and embodiments. Additionally, it is understood that one of skill in the art would appreciate these various forms and embodiments as falling within the scope of the invention as disclosed herein.

What is claimed is:

1. A floating bobber for fishing at night, said bobber comprising:
a. a body having an upper portion and a lower portion, wherein the upper portion generally floats above the water surface and the lower portion is generally submerged below the water surface when the bobber is floating, said upper portion generally having the shape of a hemispherical dome, said lower portion generally having the shape of an inverted circular cone, with at least a portion of the lower portion of the body being translucent; and,
b. an internal light, wherein said light shines downward into the water through the translucent portion of the lower portion of the body.

2. The bobber of claim 1, wherein the lower portion generally has the shape of an inverted circular cone having a concave lateral surface.

3. The bobber of claim 2, wherein the lower portion generally has the shape of an inverted circular cone having a concave lateral surface and a truncated apex, said truncated apex forming a generally flat lower surface, said lower surface being translucent.

4. The bobber of claim 1, wherein the lower portion generally has the shape of an inverted circular cone having a truncated apex, said truncated apex forming a generally flat lower surface, said lower surface being translucent.

5. The bobber of claim 1, wherein the upper portion and the lower portion of the body are substantially translucent.

6. The bobber of claim 5, wherein the upper portion and the lower portion of the body comprise green translucent plastic.

7. The bobber of claim 1, wherein the lower portion of the body comprises a weight.

8. The bobber of claim 4, further comprising a vertical cylindrical compartment for housing the light and at least one battery for powering the light, said compartment having a top end and a bottom end, said top end having female threads, said top end forming a circular opening in the upper portion of the body, said circular opening located at the top of the dome that forms the upper portion.

9. The bobber of claim 8, further comprising a cap having male threads compatible with the female threads such that the cylindrical compartment can be sealed shut by threading the cap into the top end of the compartment.

10. The bobber of claim 8, wherein the bottom end of the cylindrical compartment has an aperture into which the light is inserted, said compartment configured such that the light is positioned substantially near the translucent lower surface when the light is inserted into the aperture.

11. The bobber of claim 9, further comprising a mechanical pressure switch configured such that threading the cap tightly into the top end of the compartment activates the light by applying pressure to the switch such that an electrical connection is formed between the light and the at least one battery.

12. The bobber of claim 1, further comprising a line attachment element for attaching fishing line to the bobber, said line attachment element comprising a plastic ring attached to the outer conical surface of the lower portion of the body, said ring comprising at least one aperture for feeding the line through, said ring further comprising at least two grooves such that the line can be looped around the grooves to hold the line in place.

13. A floating bobber for fishing at night, said bobber comprising:
a. a body having an upper portion and a lower portion, wherein the upper portion generally floats above the water surface and the lower portion is generally submerged below the water surface when the bobber is floating, said upper portion generally having the shape of a hemispherical dome, said lower portion generally having the shape of an inverted circular cone having a concave lateral surface and a truncated apex, said truncated apex forming a generally flat lower surface, said lower surface being translucent;
b. an internal light, wherein said light shines downward into the water through the translucent lower surface;
c. a circular opening in the upper portion of the body, said opening located at the top of the dome forming the upper portion of the body;
d. a vertical cylindrical compartment for housing the light and at least one battery for powering the light, said compartment having a top end and a bottom end, said top end having female threads, said top end forming the circular opening in the upper portion of the body; and,
e. a cap having male threads compatible with the female threads such that the cylindrical compartment can be sealed shut by threading the cap into the top end of the compartment;

14. The bobber of claim 13, wherein the bottom end of the cylindrical compartment has an aperture into which the light is inserted, said compartment configured such that the light is positioned substantially near the translucent lower surface when the light is inserted into the aperture.

15. The bobber of claim 13, further comprising a mechanical pressure switch configured such that threading the cap tightly into the top end of the compartment activates the light by applying pressure to the switch such that an electrical connection is formed between the light and the at least one battery.

16. The bobber of claim 13, wherein the upper portion and the lower portion of the body are substantially translucent.

17. The bobber of claim 16, wherein the upper portion and the lower portion of the body comprise green translucent plastic.

18. The bobber of claim 13, wherein the lower portion of the body comprises a weight.

19. The bobber of claim 13, further comprising a line attachment element for attaching fishing line to the bobber, said line attachment element comprising a plastic ring attached to the outer conical surface of the lower portion of the body, said ring comprising at least one aperture for feeding the line through, said ring further comprising at least two grooves such that the line can be looped around the grooves to hold the line in place.

20. A method of manufacturing a floating bobber for fishing at night, said method comprising the following steps:
a. producing a plastic upper bobber housing by injection molding, said upper bobber housing generally having the shape of a hemispherical dome with a circular opening at the top of the dome, said upper bobber housing comprising a vertical cylindrical compartment located inside the dome, said compartment having a top end and a bottom end, said top end having female threads, said top end forming the circular opening at the top of the dome, said bottom end having an aperture for inserting a light;
b. producing a plastic lower bobber housing by injection molding, said lower bobber housing generally having the shape of an inverted circular cone without a base, said cone having a truncated apex, said truncated apex forming a generally flat lower surface, said lower surface being translucent, said circular cone having a circular flange corresponding to the circular edge of the hemispherical dome of the upper bobber housing;
c. permanently joining the circular flange of the lower bobber housing to the circular edge of the upper bobber housing to form a single bobber body;
d. producing a plastic cap by injection molding, said cap having male threads compatible with the female threads of the cylindrical compartment;
e. installing a light in the bobber by inserting the light through the top end of the cylindrical compartment and into the aperture at the bottom end of the cylindrical compartment;
f. installing at least one battery in the cylindrical compartment for powering the light; and,
g. threading the cap into the top end of the cylindrical compartment such that the light and the at least one battery are sealed within the cylindrical compartment.

21. The method of claim 20, wherein the lower bobber housing and upper bobber housing are permanently joined by adhesive, glue, cement, or heating.

22. The method of claim 20, wherein the inverted cone of the lower bobber housing has a concave lateral surface.
